(19) United States
(12) Patent Application Publication
(10) Pub. No.: US 2019/0242813 A1
(43) Pub. Date: Aug. 8, 2019

(54) SYSTEM, METHOD AND DEVICE FOR DIGITAL SWIMMING POOL MONITORING

(71) Applicant: David R. Stahlman, Naples, FL (US)

(72) Inventor: David R. Stahlman, Naples, FL (US)

(21) Appl. No.: 15/890,556

(22) Filed: Feb. 7, 2018

(51) Int. Cl. G01N 21/3577; G06F 9/50; G06Q 30/04; H04L 29/08; G01N 21/80; H04W 4/50

(52) U.S. Cl. CPC G01N 21/3577; G06F 9/5038; G06Q 30/04; H04W 84/18; G01N 21/80; H04W 4/50; H04L 67/12

(57) ABSTRACT

A system for monitoring a body of liquid including a sensor plug, an adapter unit, a cord, and a software application. The sensor plug including a housing and a sensor, and capable of being submerged in the liquid and making measurement of a chemical characteristic of the liquid. The adapter unit may capable of connecting to a mobile device. The cord connecting the sensor plug to the adapter unit. The software application including information relating to a volume of the body of liquid and an optimal value for the chemical characteristic, and capable of receiving a current set of measurements from the sensor plug. Upon receipt of the current set of measurements, the software module using the optimal value, the information relating to the volume of liquid, and the current set of measurements to calculate and display a series of steps to be performed to maintain the chemical characteristic.

### BACKGROUND AND FIELD OF ART

The present disclosure generally relates to the monitoring and treatment of man-treated aquatic environments. The disclosure is suitable for use with swimming pools and hot tubs, but may also be applicable to other aquatic environments, or liquid environments that require management, such as fish and coral aquariums.

Monitoring and maintaining the quality of water is important in a wide variety of settings. For example, swimming pools and hot tubs must be kept at certain levels of quality to keep users of these bodies of water free of waterborne illnesses. Similarly, quality of water must be kept within certain parameters to support a suitable environment for aquatic life. Monitor and maintenance of the quality of water is also important in maintaining a body of water's clarity, important in both the area of swimming pools and aquariums.

It is well known that bodies of water can become infected with certain pathogens that thrive and reproduce in these bodies of water. Algae is also known to grow in still bodies of water, leading to changes in chemical and physical properties of the water. In order to counteract the introduction, growth, and development of these unwanted organisms, certain chemicals are added to bodies of water to maintain suitable levels of its composition. Due to the change over time of the chemical composition of a body of water it is desirable to be able to monitor at frequent intervals conditions of the water, such as temperature, alkalinity, calcium, salinity, chlorine, cyanuric acid, and pH levels. A general aim of the present disclosure is to monitor and maintain suitable conditions and quality of water.

### SUMMARY

The following presents a simplified summary of the disclosure in order to provide a basic understanding of some aspects of the disclosure. This summary is not an extensive overview of the disclosure. It is not intended to identify key, or critical, elements of the disclosure or to delineate the scope of the disclosure. Its sole purpose is to present some concepts of the disclosure in a simplified form as a prelude to the more detailed description that is presented later.

The present disclosure is generally directed to a system, method and apparatus for monitoring and maintaining optimal levels of chemical characteristics in a body of water.

In certain embodiments, a system for monitoring the quality of a body of liquid may include a sensor plug, an adapter unit, a cord, and a software application. The sensor plug may include a housing and a sensor, where the sensor maybe capable of being submerged in the liquid and making measurement of a selected chemical characteristic of the liquid. The adapter unit may be capable of connecting to a mobile device. The cord may connect the sensor plug to the adapter unit. The software application may include information relating to a volume of the body of liquid and an optimal value for the chemical characteristic. The software application may be capable of receiving a current set of measurements from the sensor plug, whereupon receipt of the current set of measurements, the software module is capable of using the optimal value, the information relating to the volume of liquid, and the current set of measurements to calculate a series of steps to be performed to maintain the chemical characteristic. The software application displays the series of steps.

In certain embodiments, a device may include a sensor plug, an adapter unit and a cord. The sensor plug may include a housing and one or more sensors, wherein each respective one of the one or more sensors is capable of being submerged in the liquid and making a respective measurement of a respective chemical characteristic of the liquid. The adapter unit may be capable of connecting to a mobile device. The cord may connect the sensor plug to the adapter unit.

In certain embodiments, a non-transitory computer-readable medium including content configured to cause a computing device to perform a method that may include the steps of: receiving measurements from a sensor disposed in a body of liquid, wherein the measurements are indicative of a chemical characteristic of the body of liquid; comparing the measurements to a desired value for the chemical characteristic; determining a series of steps necessary to bring the chemical characteristic to the desire value, where each step in the series of steps comprising identifying a type and an amount of a chemical that should be added to the body of liquid based on a volume of the body of liquid; and displaying instructions regarding the type and the amount of chemicals to be added.

### DESCRIPTION OF THE DRAWINGS

FIG. 1 illustrates an example of a suitable computing system environment on which feature of the disclosed concept may be implemented.

FIG. 2 illustrates a typical control system for a swimming pool in accordance with the disclosed concept.

FIG. 3 illustrates an axial cross-sectional view of the pool piping with the sensor plug inserted and connected to a wall unit that communicates to a computing device wirelessly, in accordance with the disclosed concepts.

FIG. 4 illustrates a lateral cross-sectional view of the pool piping with the sensor plug inserted, in accordance with the disclosed concepts.

FIG. 5 illustrates a lateral cross-sectional view of the sensor plug inserted into a 3-Way T PVC pipe joint, in accordance with the disclosed concepts.

FIG. 6 illustrates an axial cross-sectional view of the pool piping with the sensor plug connected to a computing device through a wired connection, in accordance with the disclosed concepts.

FIG. 7 illustrates an axial cross-sectional view of the pool piping with the sensor plug submerged in the body of a swimming pool and connected to a sleeve adapter that is attached to a computing device, in accordance with the disclosed concepts.

FIG. 8 illustrates a home screen in accordance with the disclosed concepts.

FIG. 9 illustrates a customer list screen in accordance with the disclosed concepts.

FIG. 10 illustrates a customer/pool information screen in accordance with the disclosed concepts.

FIG. 11 illustrates a pool chemistry screen in accordance with the disclosed concepts.

FIG. 12 illustrates a calendar routes screen in accordance with the disclosed concepts.

FIG. 13 illustrates a weekly routes screen in accordance with the disclosed concepts.

FIG. 14 illustrates a daily routes screen in accordance with the disclosed concepts.

FIG. 15 illustrates a priorities screen in accordance with the disclosed concepts.

FIG. 16 illustrates a started repairs screen in accordance with the disclosed concepts.

FIG. 17 illustrates a completed repairs screen in accordance with the disclosed concepts.

FIG. 18 illustrates a maps/GPS screen in accordance with the disclosed concepts.

FIG. 19 illustrates a timer screen in accordance with the disclosed concepts.

### DETAILED DESCRIPTION OF ILLUSTRATIVE EMBODIMENTS

The present disclosure is generally directed to a system, method, apparatus and computer program product for measuring, monitoring, maintaining and storing bodies of water chemical levels. Accordingly, implementations of the disclosure include or involve the use of computing devices.

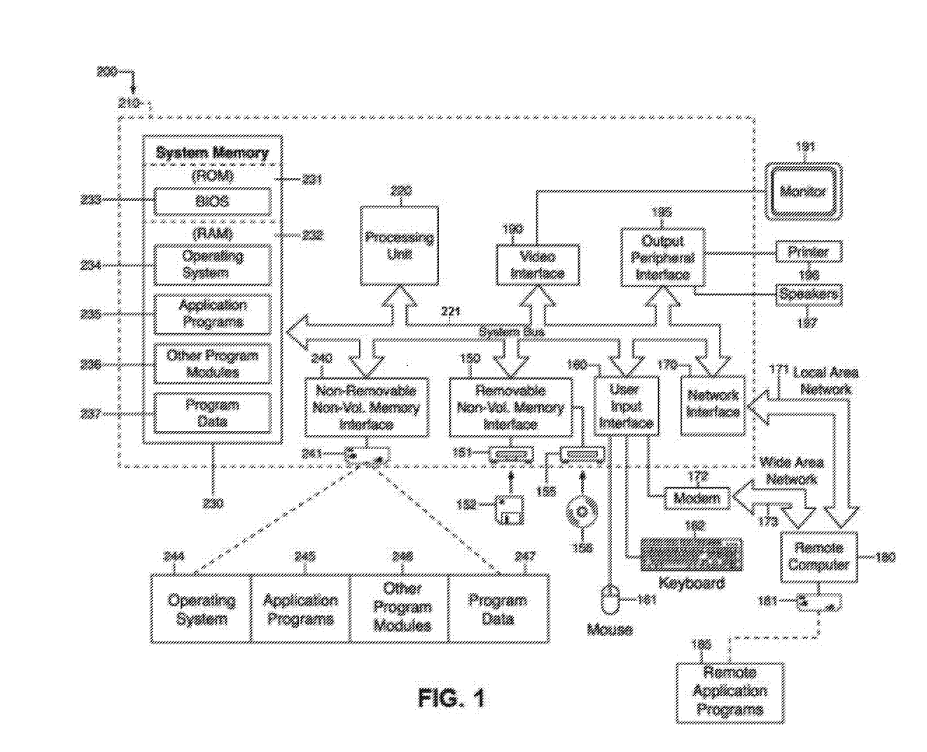

Specifically, embodiments of the present disclosure may be implemented on one or more computing devices, including one or more servers, one or more client terminals, including computer terminals, a combination thereof, or on any of myriad computing devices currently known in the art, including without limitation, personal computers, laptops, notebooks, tablet computers, touch pads (such as the Apple iPad, SmartPad Android tablet, etc.), multi-touch devices, smart phones, personal digital assistants, other multi-function devices, stand-alone kiosks, etc. An exemplary computing device for implementing a computational device is illustrated in FIG. 1.

FIG. 1 illustrates an example of a suitable computing system environment 200 on which features of the disclosure may be implemented. The computing system environment 200 is only one example of a suitable computing environment and is not intended to suggest any limitation as to the scope of use or functionality of the disclosure. Neither should the computing environment 200 be interpreted as having any requirement relating to any one or combination of components illustrated in the exemplary operating environment 200.

The disclosure is operational with numerous other computing system environments or configurations. Examples of well-known computing systems, environments, and/or configurations that may be suitable for use with the disclosure include, but are not limited to, personal computers, server computers, hand-held, notebook or laptop devices, touch pads, multi-touch devices, smart phones, other multi-function devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computing devices. Generally, program modules include routines, programs, objects, components, data structures, etc., that perform particular tasks or implement particular abstract data types. The disclosure may also be practiced in distributed computing environments where tasks are performed by remote processing devices that are linked through a communications network. In a distributed computing environment, program modules, or discrete components thereof, may be located in both local and remote computer storage media including memory storage devices and internet or cloud-based storage devices.

With reference to FIG. 1, an exemplary system that may be used for implementing the disclosure includes a computing device 210 which may be used for implementing a client, server, mobile device or other suitable environment for the disclosure. Components of computing device 210 may include, but are not limited to, a processing unit 220, a system memory 230, and a system bus 221 that couples various system components including the system memory 230 to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computing device 210 typically includes a variety of computer readable media. Computer readable media may be defined as any available media that may be accessed by computing device 210 and includes both volatile and nonvolatile media, removable and non-removable media. By way of example, and not limitation, computer readable media may include computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash, solid state, or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 210. Combinations of the any of the above should also be included within the scope of computer readable media.

The system memory 230 may include computer storage media in the form of volatile and/or nonvolatile memory such as read only memory (ROM) 231 and random access memory (RAM) 232. A basic input/output system 233 (BIOS), containing the basic routines that help to transfer information between elements within computing device 210, such as during start-up, is typically stored in ROM 231. RAM 232 typically contains data and/or program modules that are immediately accessible to and/or presently being operated on by processing unit 220. By way of example, and not limitation, FIG. 1 illustrates operating system 234, application programs 235, other program modules 236, and program data 237.

The computing device 210 may also include other removable/non-removable, volatile/nonvolatile computer storage media. By way of example only, FIG. 1 illustrates a hard disk drive 241 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computing device 210. In FIG. 1, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a keyboard 162 and pointing device 161, commonly referred to as a mouse, trackball, touch screen, or multi-touch input device. Other input devices (not shown) may include a microphone, joystick, game pad, satellite dish, scanner, movement sensor device such as the Microsoft Kinect or the like. These and other input devices are often connected to the processing unit 220 through a user input interface 160 that is coupled to the system bus 221, but may be connected by other interface and bus structures, such as a parallel port, game port or a universal serial bus (USB). A monitor 191 or other type of display device may also be connected to the system bus 221 via an interface, such as a video interface 190. In addition to the monitor 191, computers may also include other peripheral output devices such as speakers 197 and printer 196, which may be connected through an output peripheral interface 195.

The computing device 210 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computing device 210, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, the Internet, and cloud computing.

When used in a LAN networking environment, the computing device 210 is connected to the LAN 171 through a network interface or adapter 170. When used in a WAN networking environment, the computer 210 typically includes a modem 172 or other means for establishing communications over the WAN 173, such as the Internet. The modem 172, which may be internal or external, may be connected to the system bus 221 via the user input interface 160, or other appropriate mechanism. In a networked environment, program modules depicted relative to the computing device 210, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

In certain embodiments, a system for monitoring the quality of a body of liquid may include a sensor plug, an adapter unit, a cord, and a software application. The sensor plug may include a housing and a sensor, where the sensor maybe capable of being submerged in the liquid and making measurement of a selected chemical characteristic of the liquid. The adapter unit may be capable of connecting to a mobile device. The cord may connect the sensor plug to the adapter unit. The software application may include information relating to a volume of the body of liquid and an optimal value for the chemical characteristic. The software application may be capable of receiving a current set of measurements from the sensor plug, whereupon receipt of the current set of measurements, the software module is capable of using the optimal value, the information relating to the volume of liquid, and the current set of measurements to calculate a series of steps to be performed to maintain the chemical characteristic. The software application displays the series of steps.

In certain embodiments, the chemical characteristic may be selected from a group consisting of pH, calcium, alkalinity, salinity, stabilizer and chlorine. In certain embodiments, the software application may optimizes the order in which each step in the series of steps is to be performed. In certain embodiments, the software application may further be capable of utilizing cost information for chemicals that are to be used in the series of steps. In certain embodiments, the software application may optimize the order in which each step in the series of steps is to be performed based in part on the cost information. In certain embodiments, the software application may track at least one maintenance task that must be performed in order to maintain the chemical characteristic. In certain embodiments, the software application may allows identification of a priority task. In certain embodiments, the software module may track at least one started repair task. In certain embodiments, the software module may allow identification of a completed repair task. In certain embodiments, the software module may generate an invoice associated with the completed repair task.

In certain embodiments, a device may include a sensor plug, an adapter unit and a cord. The sensor plug may include a housing and one or more sensors, wherein each respective one of the one or more sensors is capable of being submerged in the liquid and making a respective measurement of a respective chemical characteristic of the liquid. The adapter unit may be capable of connecting to a mobile device. The cord may connect the sensor plug to the adapter unit.

In certain embodiments, each respective chemical characteristic is selected from the group consisting of pH, calcium, alkalinity, salinity, stabilizer and chlorine. In certain embodiments, the device may further include a depth indicator. In certain embodiments, the depth indicator comprises a float. In certain embodiments, the depth indicator comprises a colored line. In certain embodiments, the depth indicator is disposed on the cord and is located between approximately 12 inches and approximately 18 inches from the sensor plug.

In certain embodiments, a non-transitory computer-readable medium including content configured to cause a computing device to perform a method that may include the steps of: receiving measurements from a sensor disposed in a body of liquid, wherein the measurements are indicative of a chemical characteristic of the body of liquid; comparing the measurements to a desired value for the chemical characteristic; determining a series of steps necessary to bring the chemical characteristic to the desire value, where each step in the series of steps comprising identifying a type and an amount of a chemical that should be added to the body of liquid based on a volume of the body of liquid; and displaying instructions regarding the type and the amount of chemicals to be added.

In certain embodiments, the method further may further include the step of optimizing the order in which each step in the series of steps is to be performed. In certain embodiments, the method may further include utilizing cost information for the type and the amount of the chemical to be used in each step of the series of steps. In certain embodiments, the optimizing may be based in part on consideration of cost information for the type and the amount of the chemical to be used in each step.

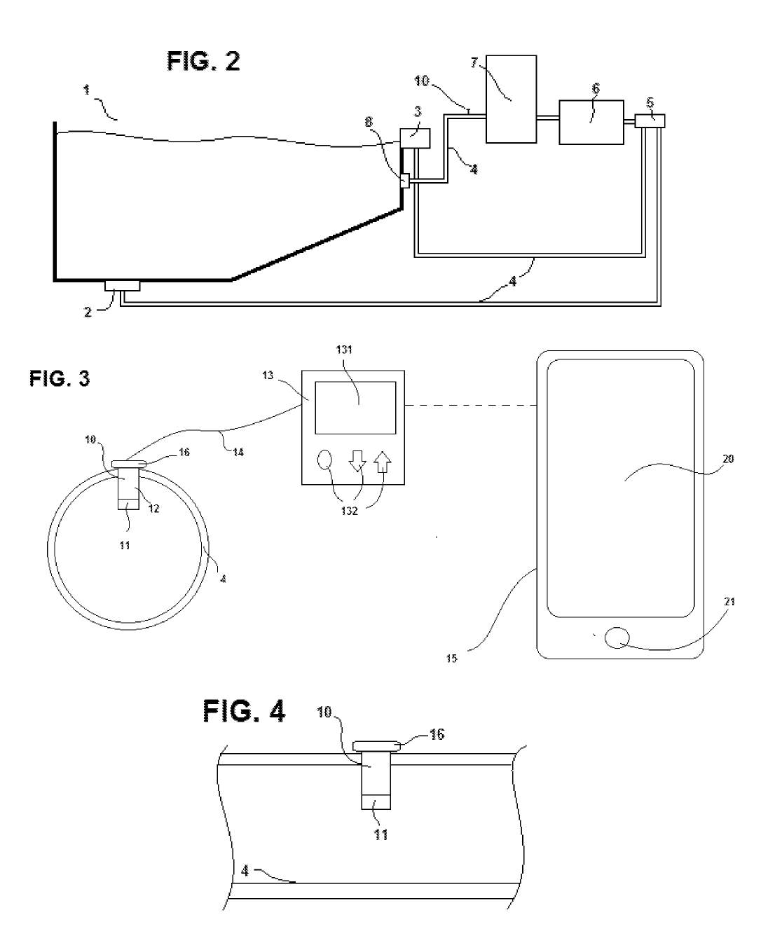

FIG. 2 illustrates the disclosed concepts implemented in a typical home swimming pool system. Swimming pool 1 is provided with a main drain 2 and skimmer 3, which draw water from swimming pool 1. The drawn water is transported from the main drain 2 and skimmer 3 to a control system 5, pump 6, and filter 7, via piping 4. The water is then transported through return 8 back into swimming pool 1 by additional piping 4. Any number and type of drains, skimmers 3 and returns 8 known in the art may be used in accordance with the disclosed concepts. For example, the swimming pool 1 may have an attached hot tub (not shown) having a separate drain and hot tub jet returns. The piping may be PVC piping, or any other suitable piping that can transport the water through the various parts of the pool system. Any suitable control system may be used with the disclosed concepts. The control may have a plurality of valves and intersections to control the flow of water. For example, manipulation of the control system 5 can isolate portions of the swimming pool, such as a hot tubs, activate or deactivate drains and returns, and direct water away from the pump—where draining the pool is the objective. Similarly, any suitable pump 6 and filter 7 may be used with the disclosed concepts.

Sensor plug 10 may be disposed in the piping 4. As shown in FIGS. 3-5, sensor plug 10 may include a housing 12, one or more sensors 11, and may optionally contain a cap portion 16. The cap 16 and housing 12 may be of any suitable size, shape and color, and may include securing features, such as a screw thread 17, compressible rubber coatings or o-rings 18, or other suitable features known in the art that help secure the sensor plug 10 to the piping 4 in a water-tight fashion. The sensors 11 may be electrodes, temperature sensors, liquid property sensors, photo-optic sensors, pressure sensors, or any other suitable sensors that measure a property of the liquid that is relative to its maintenance. For example for swimming pool 1 shown in FIG. 2, the sensor plug 10 may include one or more sensors capable of measuring one or more of chlorine, temperature, pH, alkalinity, calcium and/or stabilizers, such as cyanuric acid.

In some embodiments, the one or more sensors 11 comprise a chlorine sensor comprising a cathode and an anode. A voltage source may be provided for applying a known voltage between the anode and the cathode, wherein a positive voltage is applied to the anode and a negative voltage is applied to the cathode. The chlorine sensor output is a current signal which is indicative of the free chlorine in the swimming pool 1. In some embodiments the sensors 11 comprise a pH sensor. The pH sensor output may be an electrode from which a current signal is obtained which is indicative of the pH of the swimming pool 1. In some embodiments the sensors 11 comprises a calcium sensor. The calcium sensor may be a calcium ion-selective electrode whose output is a current signal which is indicative of the calcium level in the swimming pool 1. In some embodiments, the sensors comprise a cyanuric acid sensor. The cyanuric acid sensor output is a current signal which is indicative of the cyanuric acid level in swimming pool 1. In some embodiments, the sensors 11 comprise an alkalinity sensor. The alkalinity sensor output is a current signal which is indicative of the alkalinity level in the body of water. Because the current signal may be temperature dependent, temperature sensor may be included to calibrate the measurements and calculations made based on the current signal.

Any combination of such sensors and other sensors may be used, and is contemplated within the scope of the disclosed concepts. Each such sensor is well known in the art, and the use of any design or version of such sensors, now in existence or to be developed in the future is contemplated within the scope of the disclosed concepts. Persons of skill in the art will recognize that depending on the liquid to be monitored different sensors may be desired, and used within the scope contemplated by this disclosure. The sensor plug may include a power source, such as a battery for the sensors, or the sensors may be powered through cord 14 from a monitoring unit 13, or mobile device 15, or connection to an outlet, or other suitable power source.

It may be advantageous to position sensor plug 10 downstream of the filter 7, in the “clean water” portion of the piping 4, as shown in FIG. 2. This may increase the accuracy of sensor 11 measurements by preventing particles or debris that will be caught and removed by the filter 7 from impeding or affecting measurements taken by the sensors 11.

As shown in FIG. 3, sensor plug 10 may be connected to a monitoring unit 13 by cord 14. The wires or cables may be zip-tied to the piping 4 periodically to prevent tangles and to maintain cord 14 in an orderly fashion. The monitoring unit 13 may be mounted on the wall of a nearby building, on the filter 7, or may be located inside a nearby building. The monitoring unit 13 may receive measurements from the sensors 11. The monitoring unit 13 may be equipped with wired or wireless transmission equipment, such as Ethernet ports, Blue Tooth, or WiFi transmitters and receivers, and any other suitable communication device known in the art. The monitoring unit 13 may be powered by a battery or through a hardline connection, and may provide the sensors 11 with any power they may need to operate and take measurements. The monitoring unit 13 may be provided with memory to store the measurements from the sensors. The monitoring unit 13 may store historical values of measurements made by the sensors 11. The monitoring unit 13 may further have a display 131, capable of providing a user with current measurements from the sensors 11. The monitoring unit 13 may have input devices, such as buttons 132, allowing a user to turn on the unit and to select the measurement(s) they wish to view or take.

The monitoring unit 13 may further communicate with a mobile device 15 through wireless communication, as shown in FIG. 3 or through wired communication. The mobile device 15, may be smart phones, such as iPhone or Android devices, tablets, such as iPad or Microsoft Surface devices, PDAs, laptops, or any other suitable mobile devices known in the art. Mobile device 15 may have inputs such as one or more buttons 21, and a touch screen 20, and a display, such as touch screen 20. Accordingly, the user of the mobile device 15 may connect to the monitoring unit 13, and retrieve and review the measurement data stored therein, and make decisions about what needs to be added to the chemistry of the pool in view of the measurements. As described in greater detail below, an application may run on the mobile device 15 which automatically calculates which chemicals, and the amount of chemicals that should be added to the pool system in view of the measurements.

Additionally, integrating the monitoring unit 13, as part of the “Internet of things” is contemplated within the scope of this disclosure. The monitoring unit 13 may connect to the Internet, or to a computing device connected to the Internet, and communicate the sensor measurements to a remote monitoring application which can be accessed by maintenance personnel through a computer or mobile device 15. In some embodiments the monitoring unit 13 may be built in to the cap 16, obviating the need for a cord 14.

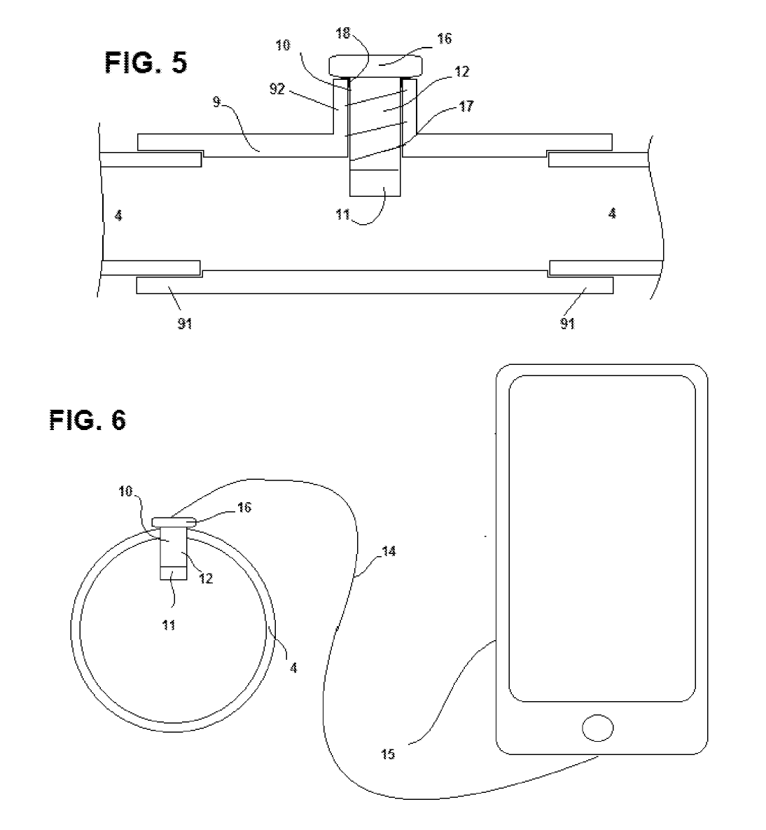

As shown in FIG. 5, existing pool systems may be modified in accordance with the disclosed concepts to include a sensor plug 10. Specifically, FIG. 5 illustrates a PVC pipe 3-way T junction, which can be used to adapt a straight piece of PVC pipe in the return pathway from the filter 7 to house the sensor plug 10. Junction 9 may have two opposing straight openings 91 which receive the existing PVC piping 4, and transverse opening 92, which may receive the sensor plug 10. As shown in FIG. 5, the housing of the sensor plug 10 may be provided with a screw thread 17, so that the sensor plug 10 can be secured to the junction 9 by screwing it in. To preserve water pressure, and prevent leaks, a rubber o-ring 18 may be provided on the housing adjacent to the cap 16, which creates a seal when the sensor plug 10 is fully inserted into the transverse opening 92. As further illustrated in FIG. 5, the one or more sensors 11 are placed in the stream of water flowing through the piping 4. As discussed above, it is advantageous to place sensor plug 10 downstream of the filter 7, so that sensor measurements can be made without interference from materials that will be captured by the filter 7.

As illustrated in FIG. 6, cord 14, may be adapted to connect directly from the sensor plug 10 to a mobile device 15, without the use of a monitoring unit. In such embodiments, the need for a wall unit is obviated, and an application running on the mobile device 15 may communicate with the sensors 11, obtain readings from same, and provide recommendation on the type and amount of chemicals that should be added to the pool system as part of maintenance.

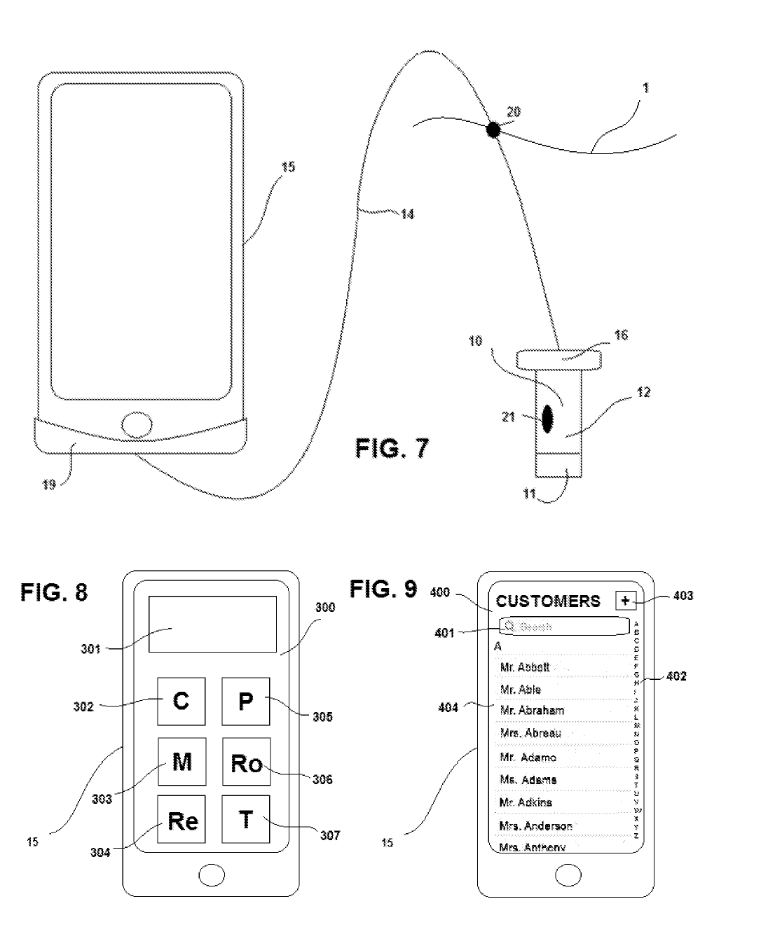

An alternative embodiment of the disclosed concepts is illustrated in FIG. 7 a sensor plug 10 may be connected to cord 14, which is in turn connected to a mobile device adapter 19. As discussed above, sensor plug 10 may have a housing 12 and one or more sensors 11. Sensor plug 10 may optionally be provided with a cap 16. The sensor plug 10 may further be provided with a weight 21, disposed or affixed inside or outside of the housing 12 or to the bottom of cord 14 near the sensor plug 10, so that the sensor plug 10 sinks when it is inserted into a swimming pool 1. Alternatively weight 21 may be integrated with and be a unitary construction with the housing 12 or cap 16. The cord 14 may be sized to be between 48 and 72 inches long, and is preferably approximately 60-65 inches long, so that the user may stand upright and insert the sensor plug 10 into the swimming pool the desired amount to obtain accurate readings. The cord 14 may be provided with an depth indicator 20. Depth indicator 20 may be a line or other indication drawn on the cord 14 at a specified distance. Alternatively depth indicator 20 may be a floatation device attached to the cord 14, or built into the cord 14 at a specified distance from the sensor plug 10. It may be advantageous to position depth indicator 20 about 12-18 inches from sensor plug 10. It may further be advantageous to make the final 12-18 inches of the cord 14 heavier than the remainder of the cord 14. Alternatively a weight 21 may be attached at or near the connection between the sensor plug 10 and the bottom of the cord 14. Adapter 19 may be designed to have a complementary attachment to mobile device 15. Accordingly, a user of this embodiment may lower the sensor plug 10 into the swimming pool 1 to approximately the depth indicator 20 on the cord 14, and obtain readings from the sensors 11 on the mobile device 15. The user can then use this information to determine the type and amount of chemicals that should be added to the pool system as part of maintenance. In some embodiments, a user may take multiple readings at various depth levels, and multiple depth indicators 20 may be provided on the cord 14.

In some embodiments, a software module may receive measurements from the sensor plug 10 and calculate the type and amount of chemicals that should be added to the swimming pool 1 to achieve optimal chemistry levels. A user may input an identifier for the swimming pool 1 or other body of liquid. The user may further input the size of the swimming pool 1 or body of water being maintained, in either gallons or dimensions. The user may further specify desired chemical levels and characteristics to be maintained, such as the optimal levels for salinity, chlorine, pH, alkalinity, calcium, cyanuric acid, and temperature of the swimming pool 1 or other body of liquid. The application may provide the user with default levels of these characteristics that the user can choose to use or modify. Once the information has been entered it is saved and used in maintenance related calculations until such time as the user changes the inputs for that swimming pool 1 or other body of liquid.

In some embodiments, the application may be programmed to display measurement information to the user. For example if the user is running the application on mobile device 15, the application may obtain readings from the sensors 11 of the sensor plug 10. The application may then display the sensor measurements on the display 20 of the mobile device 15. The application may display the chemical levels of the body of water, such as levels of salinity, chlorine, pH, alkalinity, calcium, cyanuric acid, and temperature. The application may also displays the optimal chemical levels according to the input values, and provide instructions for the user to follow to achieve the optimal chemical levels. For example, where chlorine levels are lower than desired, the application may calculate the amount of chlorine that the user must add to the swimming pool based on the size of the swimming pool 1 or other body of liquid, and the amount by which the chlorine measurement is below the optimal level for the swimming pool 1 or other body of liquid. Where chlorine levels are higher, the application may calculate the amount of water to be added to the pool based on the size of the pool and the amount by which the chlorine measurement is above the optimal level for the swimming pool. Similarly, if pH is low, the application may calculate the amount of soda ash to be added based on the size of the swimming pool 1 or other body of liquid, and the measured pH value. If pH is high, the application may calculate the amount of muriatic acid to be added based on the size of the swimming pool 1 or other body of liquid, and the measured pH value. If alkalinity is low, the application may calculate the amount of sodium bicarbonate to be added based on the size of the swimming pool 1 or other body of liquid, and the measured alkalinity value. If alkalinity is high, the application may calculate the amount of muriatic acid to be added based on the size of the swimming pool 1 or other body of liquid, and the measured alkalinity value. If calcium is low, the application may calculate the amount of calcium to be added based on the size of the swimming pool 1 or other body of liquid, and the measured calcium value. If calcium is high, the application may calculate the amount of water to be added based on the size of the swimming pool 1 or other body of liquid, and the measured calcium value. If cyanuric acid is low, the application may calculate the amount of stabilizer (cyanuric acid) to be added based on the size of the swimming pool 1 or other body of liquid, and the measured cyanuric acid value. If cyanuric acid is high, the application may calculate the amount of water to be added based on the size of the swimming pool 1 or other body of liquid, and the measured cyanuric acid value. If salinity is low, the application may calculate the amount of salt to be added based on the size of the swimming pool 1 or other body of liquid, and the measured salinity value. If salinity is high, the application may calculate the amount of water to be added based on the size of the swimming pool 1 or other body of liquid, and the measured salinity value.

If the application finds that multiple steps must be taken or that multiple chemicals should be added, the application may calculate and provide instructions on which steps must be taken in what order to bring the pool to optimal chemical levels. For example, if the measurements indicate that chlorine and cynuric acid are high (requiring dilution by adding water) but that salinity is low, a certain procedure to correct water chemistry may be suggested. Accordingly, the application may calculate the amount of dilution required (i.e. the amount of water to be added) based on the greater amount of the amounts calculated for bringing the chlorine and cyanuric acid to optimal levels, and then use that information to determine whether any chlorine or cyanuric acid (whichever required less dilution) need to be added to account for the greater amount of dilution that was required. Finally, the application may then include that information in its calculations for how much salt must be added. Having determined the steps that it would take to bring all values of the pool to optimal levels, the application would then display the list of instructions to the user for implementation. In doing so, the application removes the possibility for human error, or guess work, in maintaining optimal pool levels.

The application may further allow the user to input cost factors for each of the potential chemicals that may be added to the pool or body of water, and may be adapted to consider cost considerations in preparing its instruction lists to the user. For example, the application may be configured to optimize the steps and instructions in order to minimize the cost of maintaining the pool.

The application may also display historical levels of the swimming pool or other body of liquid, and record the change over time of the levels monitored, which may be in graph or chart format. The software module may also allow for the saving and retrieval of information for various bodies of water. Therefore, a user may be able to monitor and retrieve past chemical levels for more than one body of water. For example, a user may be able to monitor the chemical levels of a first swimming pool, accessing the first swimming pool's past chemical levels and treatment, then monitor that of a second swimming pool, then that of an aquarium, and so on, using the same apparatus and software module. The software module would also store the input values for each specific body of water, such that the input values would not have to be applied more than once.

The application may be adapted for individual households or users to manage one pool or other body of liquid, or it may be adapted for maintenance professionals that cover and maintain several pools or other bodies of liquids. In some embodiments, the application may include a home screen 300. As illustrated in FIG. 8, the home screen 300 may be configured to display a logo in a top portion 301, and may include one or more feature selectors 302-307. Users may select a feature selector 302-307 in order to access features of the application. For example, a customer button 302 may open a customer screen 400, which allows a user to access, edit or add information relating to a users' customers. Persons of skill in the art will recognize that other features and functionality may be included on the home screen 300 within the scope of the disclosed concepts.

As shown in FIG. 9, the customer screen 400 may allow a user to access, edit or add information relating to customers. The customer screen 400 may include search functionality 401, which allows a user to input a name, or partial name, and search the customer list for same, and narrow the names displayed to names which match the search terms. The search functionality may also search customer information, such as city, zip code, phone number, etc. to find customers that match the query provided. A navigation tool 402 may be included to allow a user to jump to names that begin with a certain letter, or to otherwise scroll up or down the list. An add customer button 403 may be included to allow the user to add information relating to a new customer. A customer name list 404 may be displayed showing a list of the customers of a user. The customers may be organized alphabetically by first or last name, or by any other suitable listing. As discussed above, the customer name list 404 may be narrowed through the use of the search function. Selection of a customer through the customer name list 404, or the addition of a new customer through the add customer button 403 may bring up the customer/pool Information screen 410. Persons of skill in the art will recognize that this description is exemplary and that customer/contact lists are well known in the art. Any known features commonly used in customer/contact lists, or yet to be developed, can be used within the scope of the disclosed concepts.

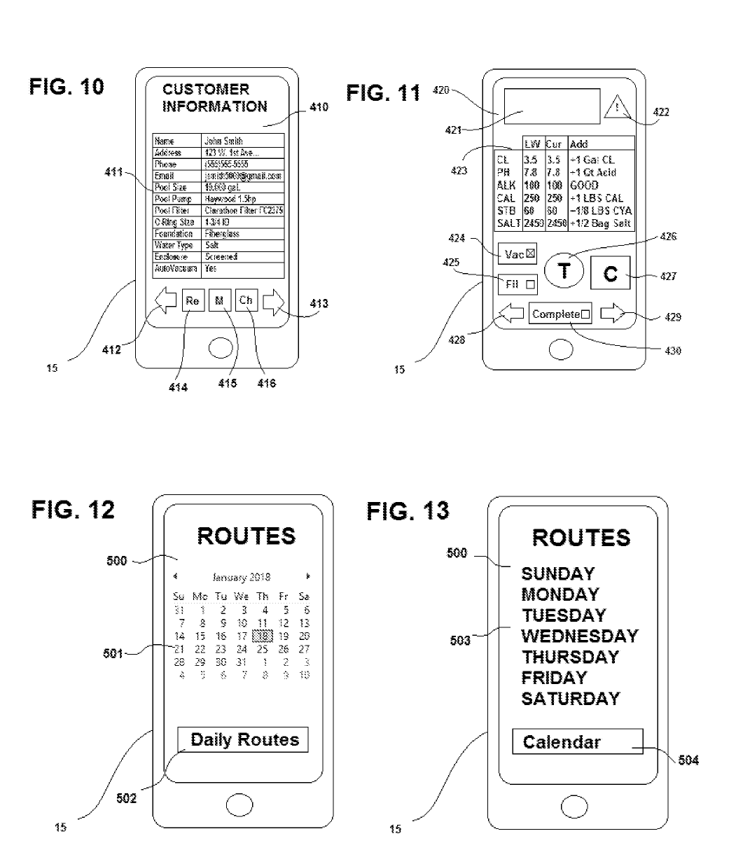

FIG. 10 illustrates the customer/pool information screen 410. The customer/pool information screen 410 may include a customer data display 411. The customer data display 411 displays customer data kept by the application for the customer, and may allow editing of same by the user. For example the customer data may include the customer's name, address, phone number, email address, the price or rate agreed to with the customer, the size of the pool (or other body of liquid to be maintained), the pool's equipment (including pump, filter, heater, and any other equipment), the foundation or surface material, the type of water (salt or fresh), whether the pool is open air or screened in, whether an automatic cleaner is used, whether the customer is up to date on payments, any schedule requirements for the customer, and any notes or other information that a user may wish to keep for the customer. Persons of skill in the art will recognize that the customer database which manages this customer data can include any other fields or records that a user may find useful to include for a customer. The customer/pool information screen 410 may include a forward button 413 and a back button 412 to allow a user to navigate to other customers. The functionality of these buttons may depend on the context in which the customer/pool information screen was called up. For example, if the customer/pool information screen 410 was called from the customer list, the forward and back buttons may select the next or previous customer on the customer list, respectively. If a search was run on the customer list prior to the opening of the customer/pool information screen 410, the forward and back buttons may display the next or previous customer which meets the search criteria for the search that was run. If the customer/pool information screen 410 was reached from a routes screen 500, 510, the forward and back buttons 413, 412 may cycle to the next or previous customer to be visited on that route. The application may be set up to cycle to the beginning or end of the respective lists when the last or first customer on the relevant list is reached and the user hits forward or back, respectively. The customer/pool information screen 410 may also include feature buttons 414-416, which bring up relevant features for a customer. For example the customer/pool information screen 410 may display a repairs button 414, which brings up information about any pending repairs that a customer may have pending. The repairs button 414 may be configured to appear only when a customer has pending repairs, or may alternatively always be displayed and allow a user to input new repairs that may be needed or underway. The customer/pool information screen 410 may include a Map/GPS button 415 which allows the user to obtain driving directions to the customers' address, and may open the map/GPS screen 800. The customer/pool information screen 410 may also include a pool chemistry button 416 that opens the pool chemistry page 420 for that customer. Persons of skill in the art will recognize that this description is illustrative of the information that may be kept and displayed, and that the disclosed concepts can be practiced with any additional features or information that a user may want to include.

FIG. 11 illustrates the pool chemistry page 420. The pool chemistry page 420 may display current and past information about pool chemistry, and provide instructions on what should be added to maintain the pool chemistry at optimal levels. The pool chemistry page 420 may include an identifying information section 421, which may display the name of the customer, the address where the pool is located, or other suitable identifying information. The pool chemistry page 420 may also include an hazard symbol button 422, which may remind the user of important, relevant information associated with the pool, for example whether there is a loose or aggressive pet present, other important instructions (reminder to close the gate when leaving, the location of keys to the maintenance shed, etc.), and other relevant notes. The hazard symbol button 422 may also allow the user to enter special conditions that may preclude the completion of maintenance, such as a broken pool pump, a leaking filter, or other similar problems. The hazard button 422 may also allow a user to identify a task as a priority to be addressed and listed on the priorities screen 600. The pool chemistry page 420 may also display a pool chemistry table 423. The pool chemistry table 423 may contain a list of chemical characteristics that are tracked for the pool or other body of liquid. For example, as shown in FIG. 11, the pool chemistry table 423 may include a listing of current and past measurements of chlorine levels, pH, calcium, stabilizer and salinity. The pool chemistry page 420 may detect the presence of a measuring device, such as the sensor plug 10 or pool cord discussed above, and take readings from same, or request current measurements for these chemical characteristics. The application may also communicate with a monitoring unit 13, as described above, and obtain current chemical characteristics from the monitoring unit 13. As discussed above, the application may calculate the optimal actions that must be taken to maintain the chemical characteristics of the pool or other body of liquid at optimal levels. As shown in FIG. 11, the pool chemistry table 423 may display this information to a user, providing instruction on how much of each chemical must be added to the pool or other body of liquid. As discussed above the application may optimize the order in which these instructions are implemented to minimize cost or otherwise increase efficiency. The order of the chemical characteristics displayed in the pool chemistry table 423 may be governed by application in view of such optimizations. The pool chemistry page 420 may also include maintenance checkboxes 424, 425, such as a vacuum checkbox 424 and a filter checkbox 425, which a user may check when he has completed that aspect of the maintenance on the pool or other body of water. The application may be implemented such that the maintenance checkboxes may display the date of the last time that maintenance act was performed. For example the vacuum checkbox 424 may indicate the last time that a pool was vacuumed, and the date will be updated when the user finishes vacuuming the pool and checks the vacuum checkbox 424. The filter checkbox 425 may keep track of information regarding the last time the filter 7 was cleaned and the last time the filter 7 was replaced. Hitting the filter checkbox 245 may allow the user to select whether he simply cleaned the filter 7, or replaced the filter 7. Optionally, the maintenance checkboxes may only be displayed when the application calculates that maintenance is required. Accordingly, if the application is set up so that vacuuming must be performed weekly, but filter cleaning must only take place once every four weeks, the user will see the vacuum checkbox 424 every week, but may only see the filter checkbox 425 once every four weeks. The pool chemistry page 420 may also include a timer button 426, which allows a user to track the amount of time spent on maintaining the pool. The timer button may also direct the user to a timer screen 900 which may allow the user to time specific maintenance tasks, such as draining or adding water to the pool. A user may hit the button 426 when maintenance begins, and a timer runs until the completed button 427 is hit. The pool chemistry page 420 may also include a button linking back to the customer's customer/pool information page 410, to allow the user to edit and update information as necessary during maintenance. The forward and back buttons, 429 and 428, respectively, may work in a similar fashion as described with respect to these buttons on the customer information screen 410.

As shown in FIGS. 12 and 13, the routes screen 500 may present the user with a calendar or with a list of days that the user can select to see the route that they must cover for the day. The routes screen 500 may display a calendar 501, which allows a specific day to be selected, and may have a daily routes button 502 allowing for a daily route display. Alternatively, the routes screen 500 may show a list of days 503 and may have a button allowing a user to select a calendar view 504.

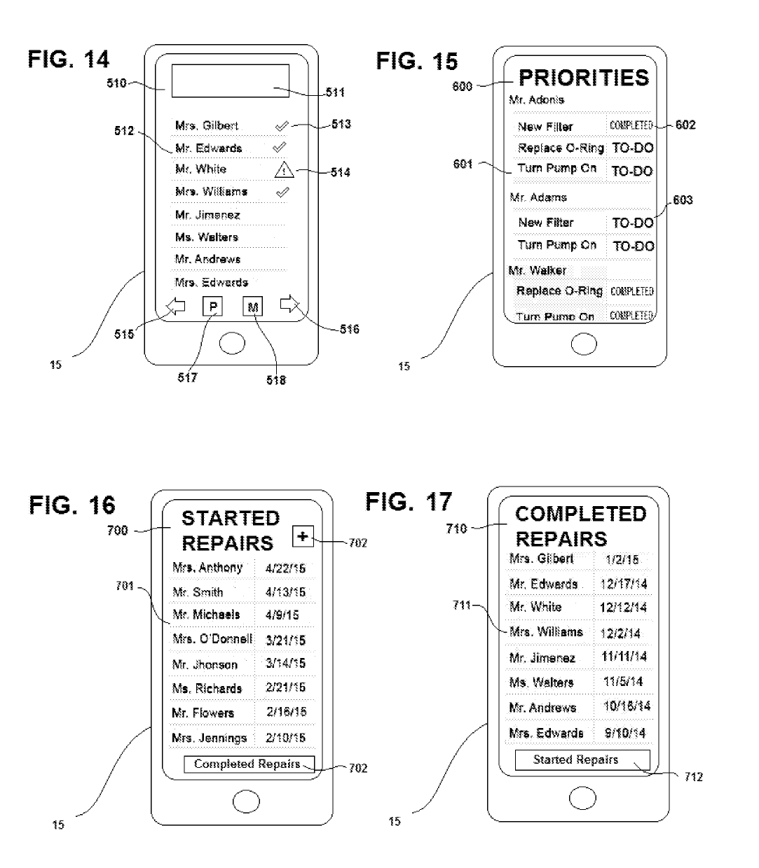

As illustrated in FIG. 14, the daily route screen 510 shows the names of the customers whose pools or other bodies of liquid need to be maintained on a particular day. The daily route screen 510 may include an identifier section 511, which identifies the day or date for which the routes are being displayed. The daily route screen 510 may also include a job list 512, which lists the customers whose pools or other bodies of liquid need to be maintained. Each job, once completed, may display a check mark 513, indicating that all necessary maintenance has been performed for that job. Alternatively, if something is not able to be performed, or special circumstances arise, such as a broken pool pump, a leaking filter, or anything else that will require additional maintenance, a hazard symbol 514 or other indicator icon may be displayed for the job. Forward and back buttons, 516, 515 may be included on the daily route screen 510 to navigate to a different day's route schedule. Feature selection buttons 517, 518 may also be included on the daily route screen 510. For example, the daily route screen 510 may include a priorities button 517, which transitions the user to a priorities screen. Similarly, the daily route screen 510 may include a maps/gps button 518 which transitions the user to a maps screen 800 leading to the next job on the routes list.

The priorities screen 600 sets forth the high-priority jobs that must be completed first in a day. The priorities screen 600 may have a job list 601 that has high priority tasks. Each task may be labeled with a to-do button 603, until such time as the user has completed the job, when it can be marked with a completed icon 602.

The repairs screen may allow a user to select repairs that have been completed, and repairs that have been started. As illustrated in FIG. 16, the started repairs screen 700 allows a user to see all pending repair jobs that are currently active. The started repairs screen 700 may include a started repair jobs list 701 which allows a user to see all pending repair jobs and select one to be modified. The user can then track the time spent on a repair job, all parts and other costs used on the repair job, and any other notes or items to be tracked or otherwise included on the invoice for the job. The user can also mark a job as completed, at which point it is removed from the started repairs list, and added to the completed repairs list. The started repairs screen 700 may also include an add job button 702 which allows a user to add a new repair job to the started repairs list. This button 702 allows a user to create a job, including the customer for whom a job is being started, the nature of the job, the applicable rates for the job, any markup for parts used on the job, any discounts that may be applied to the job, and any timing considerations or other notes for the job. The date the job is started may automatically be populated on the date the user adds the job, or if a later date is applicable, the application may allow the user to modify the start date. The started repairs screen 700 allows a user to track time worked on the job, and all parts and other resources used on the job, and to mark a job completed when the user has finished the job.

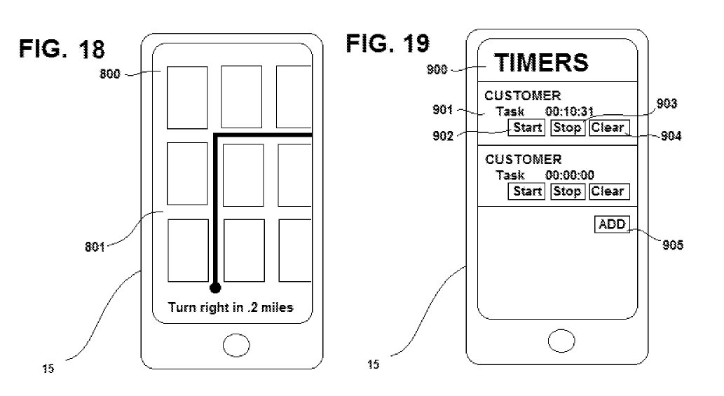

As illustrated in FIG. 17, the completed repairs screen 710 provides a list of jobs that have been completed. The completed repairs screen 710 may include a completed repair job list 711 which tracks all jobs that have been completed. This screen allows a user to select a completed job, review and revise the amounts to be billed for work and costs, and to issue a bill to the client. The completed job display 710 may be linked to a user's email and may automatically send an invoice for the job to the customer at the push of a button.

As illustrated in FIG. 18, the maps/GPS screen 800 may include a map screen 801. The map screen may be integrated with GOOLE MAPS, WAZE, or any other map/directions programs known in the art. The map screen 801 may provide a list of directions for a user to travel to and arrive at the next job to be worked.

As illustrated in FIG. 19, the timer screen 900 allows a user to track timed tasks, such as adding or draining water to a pool or other body of liquid. The timer screen 900 may include a timer task list 901, which may display information about ongoing timed tasks, including the customer name or other customer/pool information or identifying information, the nature of the task, such adding water, or draining water from a pool, and the amount of time the task has been underway. A start button 902 and a stop buttons 903 may be included for each task to allow the user to track the amount of time that the task has been underway. A clear button 904 may clear the task once the user has completed the timed maintenance task. An add button 905 may allow the user to add additional timed tasks to the task list. The timers displayed may count up—to indicate how much time the task has been running, or may count down, if the user knows how long the task should run and wants a countdown. The application may send notifications to remind the user that timed tasks are pending. For example the application may cause the mobile device 15 to beep, vibrate, or have an alarm go off as a reminder to the user. The application may be configured to do this periodically—such as every five minutes a task is running—or based on user preferences—such as where a user may want a reminder 2-5 minutes before a countdown task is complete. Persons of skill in the art will recognize that timers, such as alarm clocks and stopwatches are well known in the art, and that any features now known or to be developed for timers, including but not limited to snooze functionality, “lap” functionality, etc., can be used within the scope of the disclosed concepts.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

I claim:

1. A system for monitoring the quality of a body of liquid comprising:
a sensor plug comprising a housing and a sensor, wherein the sensor is capable of being submerged in the liquid and making measurement of a selected chemical characteristic of the liquid;
an adapter unit capable of connecting to a mobile device;
a cord connecting the sensor plug to the adapter unit; and
a software application comprising information relating to a volume of the body of liquid and an optimal value for the chemical characteristic;
wherein the software application is capable of receiving a current set of measurements from the sensor plug, whereupon receipt of the current set of measurements, the software module is capable of using the optimal value, the information relating to the volume of liquid, and the current set of measurements to calculate a series of steps to be performed to maintain the chemical characteristic; and
wherein the software application displays the series of steps.

2. The system of claim 1 wherein the chemical characteristic is selected from a group consisting of pH, calcium, alkalinity, salinity, stabilizer and chlorine.

3. The system of claim 1 wherein the software application optimizes the order in which each step in the series of steps is to be performed.

4. The system of claim 3 wherein the software application is further capable of utilizing cost information for chemicals that are to be used in the series of steps.

5. The system of claim 4 wherein the software application optimizes the order in which each step in the series of steps is to be performed based in part on the cost information.

6. The system of claim 1 wherein the software application tracks at least one maintenance task that must be performed in order to maintain the chemical characteristic.

7. The system of claim 6 wherein the software application allows identification of a priority task.

8. The system of claim 1 wherein the software module tracks at least one started repair task.

9. The system of claim 8 wherein the software module allows identification of a completed repair task.

10. The system of claim 9 wherein the software module generates an invoice associated with the completed repair task.

11. A device comprising:
a sensor plug comprising a housing and one or more sensors, wherein each respective one of the one or more sensors is capable of being submerged in the liquid and making a respective measurement of a respective chemical characteristic of the liquid;
an adapter unit capable of connecting to a mobile device; and
a cord connecting the sensor plug to the adapter unit.

12. The device of claim 11 wherein each respective chemical characteristic is selected from the group consisting of pH, calcium, alkalinity, salinity, stabilizer and chlorine.

13. The device of claim 11 further comprising a depth indicator.

14. The device of claim 13 wherein the depth indicator comprises a float.

15. The device of claim 13 wherein the depth indicator comprises a colored line.

16. The device of claim 13 wherein the depth indicator is disposed on the cord and is located between approximately 12 inches and approximately 18 inches from the sensor plug.

17. A non-transitory computer-readable medium including content configured to cause a computing device to perform a method comprising:
receiving measurements from a sensor disposed in a body of liquid, wherein the measurements are indicative of a chemical characteristic of the body of liquid;
comparing the measurements to a desired value for the chemical characteristic;
determining a series of steps necessary to bring the chemical characteristic to the desire value; each step in the series of steps comprising identifying a type and an amount of a chemical that should be added to the body of liquid based on a volume of the body of liquid; and
displaying instructions regarding the type and the amount of chemicals to be added.

18. The non-transitory computer-readable medium of claim 17 wherein the method further comprises optimizing the order in which each step in the series of steps is to be performed.

19. The non-transitory computer-readable medium of claim 17 wherein the method further comprises utilizing cost information for the type and the amount of the chemical to be used in each step in the series of steps.

20. The system of claim 18 wherein the optimizing is based in part on consideration of cost information for the type and the amount of the chemical to be used in each step in the series of steps.
